(19) United States
(12) Patent Application Publication
(10) Pub. No.: US 2025/0150954 A1
(43) Pub. Date: May 8, 2025

(54) METHOD AND DEVICE FOR SUPPORTING DYNAMIC POLICY IN WIRELESS COMMUNICATION SYSTEM

(71) Applicant: Samsung Electronics Co., Ltd., Gyeonggi-do (KR)

(72) Inventors: Dongeun SUH, Gyeonggi-do (KR); Jungshin PARK, Gyeonggi-do (KR)

(21) Appl. No.: 18/934,797

(22) Filed: Nov. 1, 2024

(30) Foreign Application Priority Data
Nov. 3, 2023 (KR) 10-2023-0150987

(51) Int. Cl. H04W 48/18; H04W 48/16; H04W 80/10

(52) U.S. Cl. CPC H04W 48/18; H04W 48/16; H04W 80/10

(57) ABSTRACT

The disclosure relates to a 5G or 6G communication system for supporting a higher data transmission rate. Specifically, the disclosure provides a method performed by a session management policy control function (SM PCF) entity in a wireless communication system, including receiving, from a session management function (SMF) entity, an SM policy control update request message including information for identifying a alternative network slice and information related to whether to retain a protocol data unit (PDU) session, identifying a network slice replacement based on the received SM policy control update request message, and transmitting, to at least one network function (NF) entity, an event exposure notify message including at least one of the information for identifying the alternative network slice or the information related to occurrence of the network slice replacement.

### CROSS-REFERENCE TO RELATED APPLICATION(S)

This application is based on and claims priority under 35 U.S.C. § 119 to Korean Patent Application No. 10-2023-0150987, filed on Nov. 3, 2023, in the Korean Intellectual Property Office, the disclosure of which is incorporated herein by reference in its entirety.

### BACKGROUND

### 1. Field

The disclosure relates generally to a wireless communication system, and more particularly, to a method and apparatus for supporting dynamic policies in a wireless communication system.

### 2. Description Of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mm Wave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### SUMMARY

The disclosure has been made to address at least the above-mentioned problems and/or disadvantages and to provide at least the advantages described below.

Accordingly, an aspect of the disclosure is to provide a method and apparatus to improve a procedure of supporting dynamic policies.

An aspect of the disclosure is to provide a method of, when a network slice is replaced, receiving information for determining a policy for a terminal from a new slice.

An aspect of the disclosure is to provide a method and apparatus by which an AM PCF updates subscription information so as to derive an optimal AM policy in a network slice replacement situation.

In accordance with an aspect of the disclosure, a method performed by a session management policy control function (SM PCF) entity in a wireless communication system, includes receiving, from a session management function (SMF) entity, an SM policy control update request message including information for identifying a alternative network slice and information related to whether to retain a protocol data unit (PDU) session, identifying a network slice replacement based on the received SM policy control update request message, and transmitting, to at least one network function (NF) entity, an event exposure notify message including at least one of the information for identifying the alternative network slice or the information related to occurrence of the network slice replacement.

In accordance with an aspect of the disclosure, a method performed by a network function (NF) entity in a wireless communication system includes receiving, from a session management policy control function (SM PCF) entity, an event exposure notify message including at least one of information for identifying a alternative network slice or information related to occurrence of a network slice replacement, wherein the event exposure notify message is based on an SM policy control update request message, and wherein the SM policy control update request message includes information for identifying the alternative network slice and information related to whether to retain a protocol data unit (PDU) session.

In accordance with an aspect of the disclosure, a session management policy control function (SM PCF) entity in a wireless communication system, including a transceiver, and a controller coupled to the transceiver, wherein the controller is configured to receive, from a session management function SMF) entity, an SM policy control update request message including information for identifying a alternative network slice and information related to whether to retain a protocol data unit (PDU) session, identify a network slice replacement based on the received SM policy control update request message, and transmit, to at least one network function (NF) entity, an event exposure notify message including at least one of the information for identifying the alternative network slice or the information related to occurrence of the network slice replacement.

In accordance with an aspect of the disclosure, a network function (NF) entity in a wireless communication system includes a transceiver, and a controller coupled to the transceiver, wherein the controller is configured to receive, from a session management policy control function (SM PCF) entity, an event exposure notify message including at least one of information for identifying a alternative network slice or information related to occurrence of a network slice replacement, wherein the event exposure notify message is based on an SM policy control update request message, and wherein the SM policy control update request message includes information for identifying the alternative network slice and information related to whether to retain a protocol data unit (PDU) session.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a structure of a 5G system according to an embodiment;

FIG. 2 illustrates a procedure for retaining a protocol data unit (PDU) session and updating a subscription request based on a notification by a binding support function (BSF) according to an embodiment;

FIG. 3 illustrates a procedure for retaining a PDU session and updating a subscription request based on a notification by an SM PCF according to an embodiment;

FIG. 4 illustrates a procedure for re-establishing a PDU session and updating a subscription request based on a notification by a BSF according to an embodiment;

FIG. 5 illustrates a structure of a UE according to an embodiment;

FIG. 6 illustrates a structure of a base station according to an embodiment; and

FIG. 7 illustrates a structure of a network entity according to an embodiment.

### DETAILED DESCRIPTION

The following description with reference to the accompanying drawings is provided to assist in a comprehensive understanding of the disclosure. It includes various specific details to assist in that understanding but these are to be regarded as merely examples. Accordingly, those of ordinary skill in the art will recognize that various changes and modifications of the various embodiments described herein can be made without departing from the scope and spirit of the disclosure. Descriptions of well-known functions and constructions may be omitted for the sake of clarity and conciseness.

Terms described below are terms defined in consideration of functions in the disclosure, which may vary according to intentions or customs of users and providers. Therefore, the definition should be made based on the content throughout this specification.

Some components are exaggerated, omitted, or schematically illustrated in the accompanying drawings. The size of each component does not fully reflect the actual size. In each drawing, the same reference numerals are given to the same or corresponding components.

Hereinafter, the disclosure will be described based on an approach of hardware. However, the disclosure may also be based on technology that uses both hardware and software, and thus, the disclosure may not exclude the perspective of software.

Terms referring to device elements (e.g., control unit, processor, an AI model, encoder, decoder, autoencoder (AE), and neural network (NN) model) and terms referring to data (e.g., signal, feedback, report, reporting, information, parameter, value, bit, and codeword) are illustratively used for the sake of descriptive convenience. Therefore, the disclosure is not limited by the terms as used below, and other terms having equivalent technical meanings may be used.

The disclosure will be described using terms used in the 3GPP but they are for illustrative purposes only and may be easily applied to other communication systems through modifications.

Throughout the specification, the same or like reference numerals designate the same or like elements.

Herein, terms and names defined in the 3GPP LTE or NR standards are used for the sake of descriptive convenience. However, the disclosure is not limited by these terms and names, and may be similarly applied to systems that conform other standards.

A base station (BS) is an entity that allocates resources to terminals, and may be at least one of a radio access network (RAN) node, a next generation node B (gNode B, gNB), an evolved node B (eNode B, eNB), a Node B, a wireless access unit, a base station controller, and a node on a network. The term eNB may be interchangeably used with the term gNB for the sake of descriptive convenience. That is, a base station described as eNB may refer to gNB.

A terminal may include a UE, a mobile station (MS), a cellular phone, a smartphone, a computer, or a multimedia system capable of performing a communication function, but is not limited thereto.

In particular, the disclosure may be applied to 3GPP NR, to intelligent services (e.g., smart homes, smart buildings, smart cities, smart cars or connected cars, healthcare, digital education, retail business, security and safety-related services, etc.) on the basis of 5G communication technology and IoT-related technology. The term terminal may refer to not only mobile phones, NR-IoT devices, and sensors, but also any other wireless communication devices.

A wireless communication system is advancing to a broadband wireless communication system for providing high-speed and high-quality packet data services using communication standards, such as high-speed packet access (HSPA) of the 3rd generation partnership project (3GPP), long-term evolution (LTE) or evolved universal terrestrial radio access (E-UTRA)), LTE-advanced (LTE-A), LTE-Pro, high-rate packet data (HRPD) of 3GPP2, ultra-mobile broadband (UMB), institute of electrical and electronics engineers (IEEE) 802.16e, and the like, as well as typical voice-based services.

As an example of the broadband wireless communication system, an LTE system employs an orthogonal frequency division multiplexing (OFDM) scheme in a downlink (DL) and employs a single carrier frequency division multiple access (SC-FDMA) scheme in an uplink (UL). The uplink refers to a radio link via which a terminal (or UE) transmits data or control signals to a base station (BS) (or eNB or gNB), and the downlink refers to a radio link via which the base station transmits data or control signals to the terminal. The above multiple access scheme separates data or control information of respective users by allocating and operating time-frequency resources for transmitting the data or control information for each user so as to avoid overlapping each other, to establish orthogonality.

Since a 5G communication system, which is a post-LTE communication system, must freely reflect various requirements of users, service providers, and the like, services satisfying various requirements must be supported. The services considered in the 5G communication system include eMBB, mMTC, URLLC, and the like.

Specifically, eMBB aims to provide a data rate higher than that supported by existing LTE, LTE-A, or LTE-Pro. For example, in the 5G communication system, eMBB must provide a peak data rate of 20 gigabits per second (Gbps) in the downlink and a peak data rate of 10 Gbps in the uplink for a single base station. The 5G communication system must provide an increased user-perceived data rate to the UE, as well as the maximum data rate. To satisfy such requirements, transmission/reception technologies including a further enhanced MIMO transmission technique are required to be improved. The data rate required for the 5G communication system may be obtained using a frequency bandwidth more than 20 megahertz (MHz) in a frequency band of 3 to 6 GHz or 6 GHz or more, instead of transmitting signals using a transmission bandwidth up to 20 MHz in a band of 2 GHz used in LTE.

In addition, mMTC is being considered to support application services such as the IoT in the 5G communication system. mMTC may have requirements, such as support of connection of a large number of UEs in a cell, enhancement coverage of UEs, improved battery time, cost reduction of a UE, and the like, to effectively provide the IoT. Since the IoT provides communication functions while being provided to various sensors and various devices, it must support many UEs (e.g., 1,000,000 UEs/km²) in a cell. The UEs supporting mMTC may require wider coverage than those of other services provided by the 5G communication system because the UEs are likely to be located in a shadowy area, such as a basement of a building, which is not covered by the cell due to the nature of the service. The UE supporting mMTC must be configured to be inexpensive, and may require a very long battery life-time such as 10 to 15 years because it is difficult to frequently replace the battery of the UE.

The URLLC, which is a cellular-based mission-critical wireless communication service, may be used for remote control for robots or machines, industrial automation, unmanned aerial vehicles, remote health care, emergency alert, and the like. Thus, URLLC must provide communication with ultra-low latency and ultra-high reliability. For example, a service supporting URLLC must satisfy an air interface latency of less than 0.5 milliseconds (ms), and may also require a packet error rate of 10⁻⁵ or less. Therefore, for the services supporting URLLC, a 5G system must provide a transmit time interval (TTI) shorter than those of other services, and also may require a design for assigning a vast array of resources in a frequency band to secure reliability of a communication link.

The eMBB, URLLC, and mMTC may be multiplexed and transmitted in a single system. In this case, different transmission/reception techniques and transmission/reception parameters may be used between services to satisfy different requirements of the respective services. However, the above-described mMTC, URLLC, and eMBB are merely examples of different types of services.

Herein, LTE, LTE-A, LTE Pro, 5G (or NR), or 6G systems will be described by way of example, but the disclosure may also be applied to other communication systems having similar technical backgrounds or channel types. In addition, based on determinations by those skilled in the art, the disclosure may be applied to other communication systems through some modifications without significantly departing from the scope of the disclosure.

In the following description, “a/b” may refer to “a” and/or “b”.

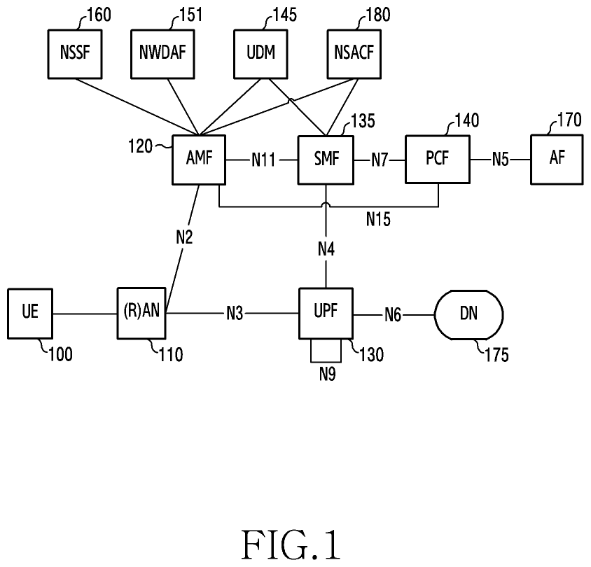

FIG. 1 illustrates a structure of a 5G system according to an embodiment.

Referring to FIG. 1, the 5G mobile communication network includes a 5G user equipment (UE, terminal), a 5G radio-access network (RAN) 110, a base station, 5G nodeB (gNB), evolved nodeB (eNB), etc.), and a 5G core network. The 5G core network may include network functions (NFs), such as an access and mobility management function (AMF) 120 which provides a mobility management function of a UE 100, a session management function (SMF) 135 which provides a session management function, a user plane function (UPF) 130 which serves to transfer data, a policy control function (PCF) 140 which provides a policy control function, a unified data management (UDM) 145 which provides a function to manage data, such as subscriber data and policy control data, and a unified data repository (UDR) which stores data of various NFs such as the UDM. The 5G core network may include additional NFs, such as a network slice selection function (NSSF) 160, a network data analytic function (NWDAF) 151, an application function (AF) 170, a data network (DN) 175, and a network slice admission control function (NSACF) 180.

In 3GPP systems, conceptual links connecting NFs in the 5G system are defined as reference points. In the following, reference points included in the 5G system architecture are provided below. Some of them are described in FIG. 1.

N1 is a reference point between a UE and an AMF

N2 is a reference point between an (R) AN and an AMF

N3 is a reference point between an (R) AN and a UPF

N4 is a reference point between an SMF and a UPF

N5 is a reference point between a PCF and an AF

N6 is a reference point between a UPF and a DN

N7 is a reference point between an SMF and a PCF

N8 is a reference point between a UDM and an AMF

N9 is a reference point between two core UPFs

N10 is a reference point between a UDM and an SMF

N11 is a reference point between an AMF and an SMF

N12 is a reference point between an AMF and an AUSF

N13 is a reference point between a UDM and an authentication server function (AUSF)

N14 is a reference point between two AMFs

N15 is a reference point between a PCF and an AMF for a non-roaming scenario, and a reference point between a PCF and an AMF in a visited network for a roaming scenario

In the 5G system, network slicing refers to a structure and a technology enabling multiple independent logical networks virtualized in a single physical network. To satisfy specialized requirements of a service/application, a network operator provides a service by configuring a virtual end-to-end network referred to as a network slice. In this case, the network slice is distinguished by an identifier referred to as single-network slice selection assistance information (S-NSSAI). The network transmits a set of allowed slices (e.g., allowed NSSAI(s)) to a UE during a UE registration procedure, and the UE transmits and receives application data via a PDU session generated via one piece of S-NSSAI (i.e., network slice) in the set of allowed slices.

A radio-access type (RAT)/frequency selection priority (RFSP) index is a parameter applied to each UE, and is a parameter to apply a radio-resource management (RRM) strategy that enables use of a specific RAT (e.g., E-UTRA or NR), frequency band, and/or the like for the UE. The RFSP index is determined by the 5G core network and then transmitted to a base station (RAN). When the base station receives the RFSP index for the UE, a specific RRM strategy for the RFSP index may be applied based on internally defined configuration information.

Service area restriction (SAR) may include an allowed area where a service is allowed to the UE, a non-allowed area where no service is allowed, etc. in a specific area. The AMF may transmit SAR to the UE and the base station (RAN). When the UE receives SAR including an allowed area, the UE may perform operation to receive a service only in the allowed area. When the UE receives SAR including a non-allowed area, the UE may not perform operation to receive a service in the non-allowed area. When the SAR is received, the RAN may perform target cell selection (e.g., selecting a cell included in the allowed area or not selecting a cell included in the non-allowed area) based on the SAR during handover (e.g., during handover based on Xn (interface between base stations) or N2-based handover).

In addition, to dynamically determine access and mobility-related policy information (e.g., RFSP index or service area restriction), an access and mobility (AM) PCF may transmit, to the BSF or session management (SM) PCF, a subscription message for requesting to notify of establishment and release of an SM policy association for a data network name (DNN) and S-NSSAI.

When a network slice has been replaced from the S-NSSAI to alternative S-NSSAI or vice-versa, there is a need in the art for a method for the AM PCF to receive establishment/release information of an SM policy association for the alternative S-NSSAI (or for the S-NSSAI).

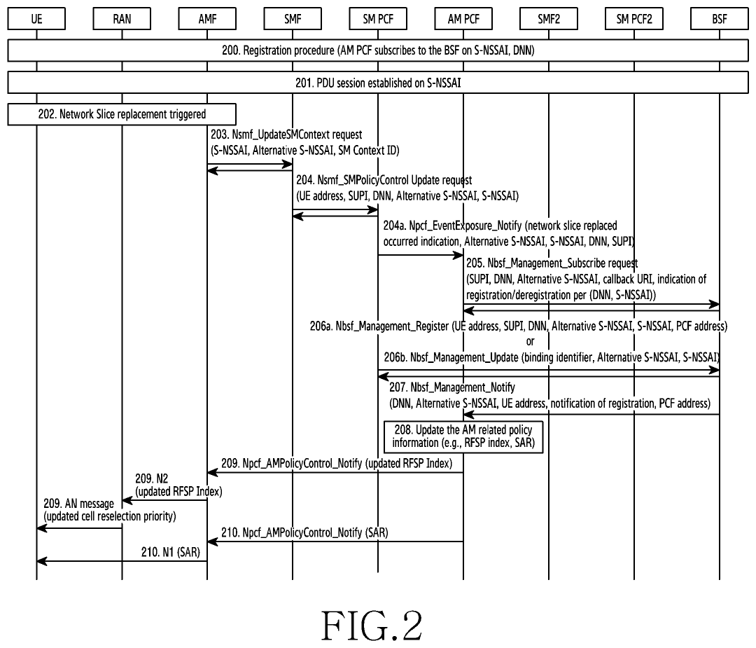

FIG. 2 illustrates a procedure for retaining a PDU session and updating a subscription request based on a notification by a BSF according to an embodiment.

Referring to FIG. 2, a scheme of notification via a BSF is disclosed as a method for, when a network slice is replaced, updating a subscription request for SM policy association establishment/termination for replaced S-NSSAI.

In this disclosure, a PCF for a UE may refer to an AM PCF and a UE PCF.

A PCF for a PDU session may be used to refer to an SM PCF.

Referring to FIG. 2, a UE registration procedure is performed in step 200. A UE transmits a registration request to an AMF via a RAN, the AMF receives subscription information of the UE (e.g., an RFSP index and a SAR may be included) from UDM, and then, to acquire an AM policy for the UE, the AMF transmits, to an AM PCF, a message for requesting the AM policy. The request message that the AMF transmits to the AM PCF may include the RFSP index and SAR information received from the UDM. When the RFSP index and SAR information included in the message received from the AMF are included, the AM PCF may determine, based on this information, an RFSP index or SAR to be applied, and then may add the same to a response message transmitted to the AMF.

In this case, when access and mobility-related policy information (e.g., the RFSP index or SAR) varies depending on an application in use, the AM PCF may transmit a subscription request message to an SM PCF via a BSF or the AMF and an SMF according to an operator policy of the AM PCF, wherein the request message is to request a notification to the AM PCF when a session policy association is established or terminated for the UE and for an S-NSSAI/DNN pair (e.g., in a case of the BSF or when a new SM PCF is registered for a subscription permanent identifier (SUPI)_(or UE identifier information), S-NSSAI, or DNN).

When the AM PCF has determined to transmit, to the BSF, the subscription request message for requesting to notify the AM PCF of the establishment or termination of the session policy association for the UE and for the S-NSSAI/DNN pair, the AM PCF may transmit the request message including the following information, although the disclosure is not limited thereto.

### SUPI

DNN/S-NSSAI: a DNN/S-NSSAI pair. The AM PCF may add, to the request message, a DNN/S-NSSAI pair stored as configuration information for each application or a DNN/S-NSSAI pair identified by information received from a third party (e.g., application function (AF)).

### Address Information for Reception of a Notification (e.g., a Callback URI)

Indication of registration or deregistration: When the AM PCF determines, based on a notification transmitted by the BSF, that access and mobility-related policy information may change when establishing and terminating an SM policy association for DNN and S-NSSAI, the AM PCF may add an indication of registration or deregistration per DNN/S-NSSAI to the message transmitted to the BSF. The BSF reports SM PCF registration when a first SM policy association is established for the S-NSSAI and DNN, and reports SM PCF deregistration when a last SM policy association is terminated for the S-NSSAI and DNN.

However, the information to be included is not limited thereto. When S-NSSAI is replaced for the UE (i.e., when network slice replacement for the UE occurs), the AM PCF may transmit, to the SM PCF via the AMF and the SMF, information requesting to notify the AM PCF of the replacement.

The message may include an event ID indicating a notification of the network slice replacement.

When a message including S-NSSAI and alternative S-NSSAI is received from the SMF, the SM PCF may add a network slice replacement occurred indication and the alternative S-NSSAI to a notification (or report) message transmitted to the AM PCF.

The AMF transmits a registration acceptance message to the UE via the RAN.

In step 201 of FIG. 2, when a PDU session for transmitting application traffic is required, the UE may transmit a PDU session establishment request message to the AMF via the RAN.

The AMF establishes a PDU session via S-NSSAI determined by itself or the S-NSSAI included in the message received from the UE.

In step 202, when a message indicating that the S-NSSAI is unavailable is received from an OAM, an NSSF, or the AM PCF, the AMF may determine to replace the S-NSSAI with the alternative S-NSSAI for the UE.

If mapping of alternative S-NSSAI (i.e., information indicating that alternative S-NSSAI should be used instead of S-NSSAI) and the alternative S-NSSAI are not included in allowed NSSAI (i.e., information including allowed network slice identifier(s)) and/or configured NSSAI (i.e., information including configured network slice identifier(s)), the AMF may transmit allowed NSSAI and/or configured NSSAI including the alternative S-NSSAI to the UE, respectively.

In step 203, when there is a PDU session associated with the S-NSSAI for the UE, the AMF may transmit a message (e.g., Nsmf_UpdateSMcontext request or Nsmf_ReleaseSMcontext request) including the alternative S-NSSAI, the S-NSSAI, and an SM context ID (i.e., a context information identifier for the PDU session) to the SMF that is in charge of the PDU session.

In step 204, after receiving the message in step 203, the SMF may determine whether to retain the PDU session or to re-establish a PDU session, for network slice replacement.

The SMF may transmit, to the SM PCF for the PDU session, a message including UE address, SUPI, DNN, alternative S-NSSAI, S-NSSAI, SM policy context ID (i.e., SM policy identifier for the PDU session), and a retained indication (information indicating that the PDU session or SM policy association will be retained) (this information may be included when the SMF determines to retain the PDU session) or not-retained indication (information indicating that the PDU session or SM policy association will be released) (this information may be included when the SMF determines to re-establish the PDU session).

When the message of step 204 is received from the SMF, the SM PCF may determine that the S-NSSAI for the PDU session has been replaced with the alternative S-NSSAI.

When the SM PCF has received the subscription request for a network slice replacement event from the AM PCF in step 200 or step 201, the SM PCF may transmit, to the AM PCF in step 204a, a message including one or more of network slice replacement occurred indication (i.e., an indication indicating that a network slice change has occurred), and alternative S-NSSAI, S-NSSAI, SUPI, UE address, notification correlation information.

When the message of step 204a includes the network slice replacement occurred indication and the alternative S-NSSAI, the AM PCF may identify the replaced S-NSSAI (e.g., S-NSSAI for notification correlation information or the S-NSSAI included in step 204a) in step 205.

When the subscription for an SM policy association establishment/termination event exists for the BSF in relation to the replaced S-NSSAI (e.g., when the AM PCF has transmitted the subscription request for the replaced S-NSSAI to the BSF in step 200 or step 201, or when a subscription correlation ID for the replaced S-NSSAI exists for the BSF), the AM PCF may cancel the subscription and make a new subscription request, or perform subscription updating via a new subscription request.

When the AM PCF cancels the subscription, the AM PCF may transmit Nbsf_Management_Unsubscribe request (subscription correlation ID) to the BSF.

The AM PCF may transmit, to the BSF, a subscription request message including the following information.

### SUPI

DNN/S-NSSAI: a DNN/S-NSSAI pair. The AM PCF may add a DNN/S-NSSAI pair stored as configuration information for each application or a DNN/S-NSSAI pair identified by information received from an AF. In this case, when the AM PCF receives information indicating that the S-NSSAI has been replaced with the alternative S-NSSAI, the AM PCF may add the alternative S-NSSAI instead of the S-NSSAI.

### Address Information for Reception of a Notification (e.g., a Callback URI)

Indication of registration or deregistration: When the AM PCF determines, based on a notification transmitted by the BSF, that access and mobility-related policy information may change when establishing and terminating an SM policy association for DNN and S-NSSAI, the AM PCF may add an indication of registration or deregistration per DNN/S-NSSAI to the message transmitted to the BSF. The BSF reports SM PCF registration when a first SM policy association is established for the S-NSSAI and DNN, and reports SM PCF deregistration when a last SM policy association is terminated for the S-NSSAI and DNN.

The SM PCF may transmit the message of step 206a or the message of step 206b only if the message of step 204 includes a retained indication.

The SM PCF may transmit the message of step 206a or the message of step 206b only if the message of step 204 does not include a not-retained indication.

When the message of step 204 is received, the SM PCF may transmit a message for registration or updating of binding information to the BSF, in step 206a.

The message may include one or more among the UE address, the SUPI, the DNN, the alternative S-NSSAI, the S-NSSAI, and a PCF address.

When the message is received, the BSF may generate binding information including the UE address, the SUPI, the DNN, the alternative S-NSSAI, the S-NSSAI, or the PCF address.

Alternatively, when the message of step 204 is received, the SM PCF may transmit a message for updating of the binding information to the BSF, in step 206b.

The message may include one or more among the UE address, a binding identifier, the alternative S-NSSAI, and a network slice addition indication (i.e., an indication indicating to add the alternative S-NSSAI to the binding information).

When the BSF receives the subscription request message including the alternative S-NSSAI from the AM PCF in step 205, if the binding information including the alternative S-NSSAI is generated in step 206a or step 206b, the BSF may transmit a message for notifying of the network slice replacement, SM PCF registration, and/or SM PCF deregistration to the AM PCF in step 207.

The message may include DNN, alternative S-NSSAI, UE address, SUPI, notification of registration (i.e., information indicating that the SM PCF has been registered with DNN and alternative S-NSSAI), and PCF address, but the disclosure is not limited thereto.

When the message of step 207 is received, the AM PCF may update the RFSP index or SAR in step 208.

In step 209, when the AM PCF determines to update the RFSP index, the AM PCF may transmit the updated RFSP index to the RAN via the AMF. When the updated RFSP index is received, the RAN may transmit corresponding cell reselection priority to the UE.

In step 210, when the AM PCF determines to update the SAR, the AM PCF may transmit the updated SAR to the UE via the AMF and the RAN.

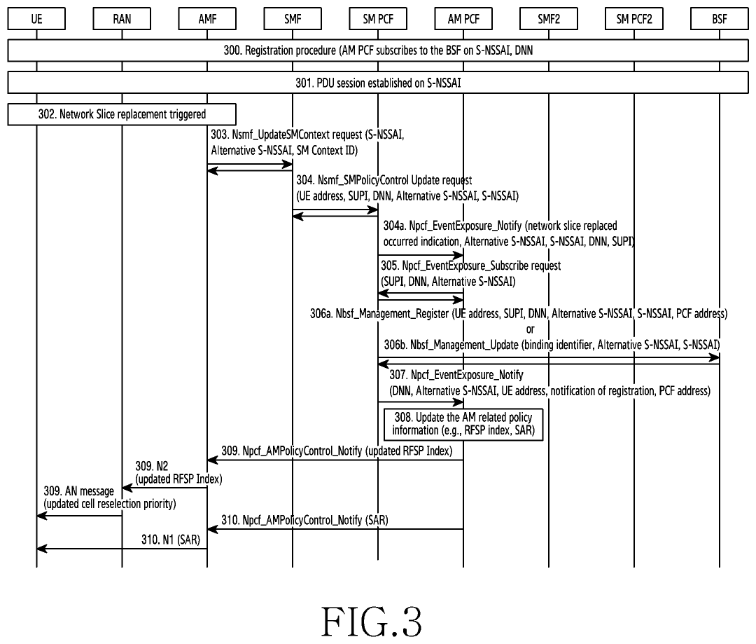

FIG. 3 illustrates a procedure for retaining a PDU session and updating a subscription request based on a notification by an SM PCF according to an embodiment.

Referring to FIG. 3, a scheme of notification via an SM PCF is disclosed as a method for, when a network slice is replaced, updating a subscription request for SM policy association establishment/termination for replaced S-NSSAI.

A UE registration procedure is performed in step 300. A UE transmits a registration request to an AMF via a RAN, the AMF receives subscription information of the UE (e.g., an RFSP index and a SAR may be included) from UDM, and then, to acquire an AM policy for the UE, the AMF transmits, to an AM PCF, a message for requesting the AM policy. The request message that the AMF transmits to the AM PCF may include the RFSP index and SAR information received from the UDM. When the RFSP index and SAR information included in the message received from the AMF are included, the AM PCF may determine, based on this information, an RFSP index or SAR to be applied, and then may add the same to a response message transmitted to the AMF.

In this case, when access and mobility-related policy information (e.g., the RFSP index or SAR) varies depending on an application in use, the AM PCF may transmit a subscription request message to an SM PCF via a BSF or the AMF and an SMF according to an operator policy of the AM PCF, wherein the request message is to request a notification when a session policy association is established or terminated for the UE and for an S-NSSAI/DNN pair (e.g., in a case of the BSF or when a new SM PCF is registered for SUPI (or UE address), S-NSSAI, or DNN).

When the AM PCF has determined to transmit the subscription request message for requesting to notify of the establishment or termination of the session policy association for the UE and for the S-NSSAI/DNN pair, the AM PCF may transmit the request message including one or more pieces of the following information to the SM PCF via the AMF and the SMF (i.e., the request message may be delivered from the AM PCF to the AMF, the SMF, and the SM PCF in that order). However, the disclosure is not limited thereto.

Event ID: An event identifier indicating a session policy association establishment/terminated event is included.

### SUPI

DNN/S-NSSAI: a DNN/S-NSSAI pair. The AM PCF may add, to the request message, a DNN/S-NSSAI pair stored as configuration information for each application or a DNN/S-NSSAI pair identified by information received from an AF).

### Address Information for Reception of a Notification

When S-NSSAI is replaced for the UE (i.e., when network slice replacement for the UE occurs), the AM PCF may transmit, to the SM PCF via the AMF and the SMF, information requesting to notify the AM PCF of the replacement.

The message may include an event ID indicating a notification of the network slice replacement.

When a message including S-NSSAI and alternative S-NSSAI is received from the SMF, the SM PCF may add a network slice replacement occurred indication and the alternative S-NSSAI to a notification (or report) message transmitted to the AM PCF.

When the AM PCF determines, based on a notification transmitted by the BSF, that access and mobility-related policy information may change when establishing and terminating an SM policy association for DNN and S-NSSAI, the PCF may add an indication of registration or deregistration per DNN/S-NSSAI to the message transmitted to the BSF. The BSF may report PCF registration for a PDU session when a first SM policy association is established, and report PCF deregistration for the PDU session when a last SM policy association is terminated for the DNN and S-NSSAI.

The AMF transmits a registration acceptance message to the UE via the RAN.

in step 301 in FIG. 3, when a PDU session for transmitting application traffic is required, the UE may transmit a PDU session establishment request message to the AMF via the RAN.

The AMF establishes a PDU session via S-NSSAI determined by itself or the S-NSSAI included in the message received from the UE.

In step 302, when a message indicating that S-NSSAI is unavailable is received from an OAM, an NSSF, or the AM PCF, the AMF may determine to replace the S-NSSAI with alternative S-NSSAI for the UE.

If mapping of alternative S-NSSAI (i.e., information indicating that alternative S-NSSAI should be used instead of S-NSSAI) and the alternative S-NSSAI are not included in allowed NSSAI (i.e., information including allowed network slice identifier(s)) and/or configured NSSAI (i.e., information including configured network slice identifier(s)), the AMF may transmit allowed NSSAI and/or configured NSSAI including the alternative S-NSSAI to the UE, respectively.

In step 303, when there is a PDU session associated with the S-NSSAI for the UE, the AMF may transmit a message (e.g., Nsmf_UpdateSMcontext request or Nsmf_ReleaseSMcontext request) including the alternative S-NSSAI, the S-NSSAI, and an SM context ID (i.e., a context information identifier for the PDU session) to the SMF that is in charge of the PDU session.

In step 304, after receiving the message in step 303, the SMF may determine whether to retain the PDU session or to re-establish a PDU session, for network slice replacement.

The SMF may transmit, to the SM PCF for the PDU session, a message including a UE address, SUPI, DNN, alternative S-NSSAI, S-NSSAI, SM policy context ID (i.e., SM policy identifier for the PDU session), and a retained indication (information indicating that the PDU session or SM policy association will be retained) (this information may be included when the SMF determines to retain the PDU session) or not-retained indication (information indicating that the PDU session or SM policy association will be released) (this information may be included when the SMF determines to re-establish the PDU session).

When the message of step 304 is received from the SMF, the SM PCF may determine that the S-NSSAI for the PDU session has been replaced with the alternative S-NSSAI.

When the SM PCF has received the subscription request for a network slice replacement event from the AM PCF in step 300 or 301, the SM PCF may transmit, to the AM PCF in step 304a. a message including one or more of a network slice replacement occurred indication (i.e., an indication indicating that a network slice change has occurred), and alternative S-NSSAI, S-NSSAI, SUPI, UE address, notification correlation information.

When the message of step 304a includes the network slice replacement occurred indication and the alternative S-NSSAI, the AM PCF may identify the replaced S-NSSAI (e.g., S-NSSAI for notification correlation information or the S-NSSAI included in step 304a) in step 305.

When a subscription for an SM policy association establishment/termination event exists for the SM PCF in relation to the replaced S-NSSAI (e.g., when the AM PCF has transmitted the subscription request for the replaced S-NSSAI to the SM PCF via the AMF and the SMF in step 300 or 301, or when a notification correlation ID for the replaced S-NSSAI exists for the SM PCF), the AM PCF may cancel the subscription and make a new subscription request, or perform subscription updating via a new subscription request.

When the AM PCF cancels the subscription, the AM PCF may transmit Npcf_EventExposure_Unsubscribe request (notification correlation ID) to the SM PCF.

The AM PCF may transmit, to the SM PCF, a subscription request message including the following information. Step 305 indicates a logical flow, where information transmitted to the SM PCF by the AM PCF is first transmitted from the AM PCF to the AMF, transmitted from the AMF to the SMF, and then transmitted from the SMF to the SM-PCF.

Event ID: An event identifier indicating a session policy association establishment/terminated event is included.

### SUPI

DNN/S-NSSAI: a DNN/S-NSSAI pair. The AM PCF may add a DNN/S-NSSAI pair stored as configuration information for each application or a DNN/S-NSSAI pair identified by information received from an AF). In this case, when the AM PCF receives information indicating that the S-NSSAI has been replaced with the alternative S-NSSAI, the AM PCF may add the alternative S-NSSAI instead of the S-NSSAI.

### Address Information for Reception of a Notification

The SM PCF may transmit the message of step 306a or the message of step 306b only if the message of step 304 includes a retained indication.

The SM PCF may transmit the message of step 306a or the message of step 306b only if the message of step 304 does not include a not-retained indication.

When the message of step 304 is received, the SM PCF may transmit a message for registration or updating of binding information to the BSF, in step 306a.

The message may include one or more among the UE address, the SUPI, the DNN, the alternative S-NSSAI, the S-NSSAI, and a PCF address.

When the message is received, the BSF may generate binding information including the UE address, the SUPI, the DNN, the alternative S-NSSAI, the S-NSSAI, or the PCF address.

Alternatively, when the message of step 304 is received, the SM PCF may transmit a message for updating of the binding information to the BSF, in step 306b.

The message may include one or more among the UE address, a binding identifier, the alternative S-NSSAI, and a network slice addition indication (i.e., an indication indicating to add the alternative S-NSSAI to the binding information).

When the SM PCF receives the subscription request message including the alternative S-NSSAI from the AM PCF (via the SMF) in step 305, if a new SM policy association including the alternative S-NSSAI is established in step 306a or 306b, or if the S-NSSAI in existing SM policy associations is changed to the alternative S-NSSAI, the SM PCF may transmit a message to notify of the changed S-NSSAI to the AM PCF in step 307.

The message may include DNN, alternative S-NSSAI, UE address, SUPI, and notification of registration (i.e., information indicating that SM policy association has been established with DNN and alternative S-NSSAI), but the disclosure is not limited thereto.

When the message of step 307 is received, the AM PCF may update the RFSP index or SAR in step 308.

In step 309, when the AM PCF determines to update the RFSP index, the AM PCF may transmit the updated RFSP index to the RAN via the AMF. When the updated RFSP index is received, the RAN may transmit corresponding cell reselection priority to the UE.

In step 310, when the AM PCF determines to update the SAR, the AM PCF may transmit the updated SAR to the UE via the AMF and the RAN.

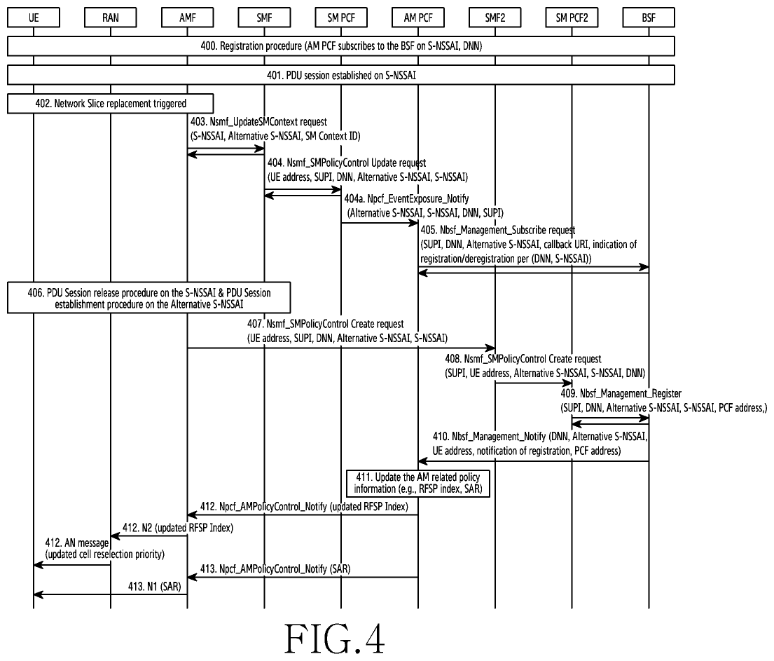

FIG. 4 illustrates a procedure for re-establishing a PDU session and updating a subscription request based on a notification by a BSF according to an embodiment.

Referring to FIG. 4, a scheme of notification via a BSF is disclosed as a method for, when a network slice is replaced via PDU session re-establishment, updating a subscription request for SM policy association establishment/termination for replaced S-NSSAI.

A UE registration procedure is performed in step 400. A UE transmits a registration request to an AMF via a RAN, the AMF receives subscription information of the UE (e.g., an RFSP index and a SAR may be included) from UDM, and then, to acquire an AM policy for the UE, the AMF transmits, to an AM PCF, a message for requesting the AM policy. The request message that the AMF transmits to the AM PCF may include the RFSP index and SAR information received from the UDM. When the RFSP index and SAR information included in the message received from the AMF are included, the AM PCF may determine, based on this, an RFSP index or SAR to be applied, and then may add the same to a response message transmitted to the AMF.

In this case, when access and mobility-related policy information (e.g., the RFSP index or SAR) varies depending on an application in use, the AM PCF may transmit a subscription request message to an SM PCF via a BSF or the AMF and an SMF according to an operator policy of the AM PCF, wherein the request message is to request a notification when a session policy association is established or terminated for the UE and for an S-NSSAI/DNN pair (e.g., in a case of the BSF or when a new SM PCF is registered for SUPI (or UE address), S-NSSAI, or DNN).

When the AM PCF has determined to transmit the subscription request message for requesting to notify of the establishment or termination of the session policy association for the UE and for the S-NSSAI/DNN pair, the AM PCF may transmit the request message including the following information to the BSF. However, the disclosure is not limited thereto.

### SUPI

DNN/S-NSSAI: a DNN/S-NSSAI pair. The AM PCF may add, to the request message, a DNN/S-NSSAI pair stored as configuration information for each application or a DNN/S-NSSAI pair identified by information received from an AF.

### Address Information for Reception of a Notification (e.g., a Callback URI)

Indication of registration or deregistration: When the AM PCF determines, based on a notification transmitted by the BSF, that access and mobility-related policy information may change when establishing and terminating an SM policy association for DNN and S-NSSAI, the AM PCF may add an indication of registration or deregistration per DNN/S-NSSAI to the message transmitted to the BSF. The BSF reports SM PCF registration when a first SM policy association is established for corresponding S-NSSAI and DNN, and reports SM PCF deregistration when a last SM policy association is terminated for corresponding S-NSSAI and DNN.

When S-NSSAI is replaced for the UE (i.e., when network slice replacement for the UE occurs), the AM PCF may transmit, to the SM PCF via the AMF and the SMF, information requesting to notify the AM PCF of the replacement.

The message may include an event ID indicating a notification of the network slice replacement.

When a message including S-NSSAI and alternative S-NSSAI is received from the SMF, the SM PCF may add a network slice replacement occurred indication and the alternative S-NSSAI to a notification (or report) message transmitted to the AM PCF.

The AMF transmits a registration acceptance message to the UE via the RAN.

In step 401, when a PDU session for transmitting application traffic is required, the UE may transmit a PDU session establishment request message to the AMF via the RAN.

The AMF establishes a PDU session via S-NSSAI determined by itself or the S-NSSAI included in the message received from the UE.

In step 402, when a message indicating that S-NSSAI is unavailable is received from an OAM, an NSSF, or the AM PCF, the AMF may determine to replace the S-NSSAI with alternative S-NSSAI for the UE.

If mapping of alternative S-NSSAI (i.e., information indicating that alternative S-NSSAI should be used instead of S-NSSAI) and the alternative S-NSSAI are not included in allowed NSSAI (i.e., information including allowed network slice identifier(s)) and/or configured NSSAI (i.e., information including configured network slice identifier(s)), the AMF may transmit allowed NSSAI and/or configured NSSAI including the alternative S-NSSAI to the UE, respectively.

In step 403, when there is a PDU session associated with the S-NSSAI for the UE, the AMF may transmit a message (e.g., Nsmf_UpdateSMContext request or Nsmf_ReleaseSMContext request) including the alternative S-NSSAI, the S-NSSAI, and an SM context ID (i.e., a context information identifier for the PDU session) to the SMF that is in charge of the PDU session.

In step 404, after receiving the message in step 403, the SMF may determine whether to retain the PDU session or to re-establish a PDU session, for network slice replacement.

The SMF may transmit, to the SM PCF for the PDU session, a message including a UE address, SUPI, DNN, alternative S-NSSAI, S-NSSAI, SM policy context ID (i.e., SM policy identifier for the PDU session), and a retained indication (information indicating that the PDU session or SM policy association will be retained) (this information may be included when the SMF determines to retain the PDU session) or not-retained indication (information indicating that the PDU session or SM policy association will be released) (this information may be included when the SMF determines to re-establish the PDU session).

When the message of step 404 is received from the SMF, the SM PCF may determine that the S-NSSAI for the PDU session has been replaced with the alternative S-NSSAI.

When the SM PCF has received the subscription request for a network slice replacement event from the AM PCF in step 400 or 401, the SM PCF may transmit, to the AM PCF in step 404a, a message including one or more of network slice replacement occurred indication (i.e., an indication indicating that a network slice change has occurred), and alternative S-NSSAI, S-NSSAI, SUPI, UE address, notification correlation information.

When the message of step 404a includes the network slice replacement occurred indication and the alternative S-NSSAI, the AM PCF may identify the replaced S-NSSAI (e.g., S-NSSAI for notification correlation information or the S-NSSAI included in step 404a) in step 405.

When a subscription for an SM policy association establishment/termination event exists for the BSF in relation to the replaced S-NSSAI (e.g., when the AM PCF has transmitted the subscription request for the replaced S-NSSAI to the BSF in step 400 or operation 1, or when a subscription correlation ID for the replaced S-NSSAI exists for the BSF), the AM PCF may cancel the subscription and make a new subscription request, or perform subscription updating via a new subscription request.

When the AM PCF cancels the subscription, the AM PCF may transmit an Nbsf_Management_Unsubscribe request (subscription correlation ID) to the BSF.

The AM PCF may transmit, to the BSF, a subscription request message including the following information.

### SUPI

DNN/S-NSSAI: a DNN/S-NSSAI pair. The AM PCF may add a DNN/S-NSSAI pair stored as configuration information for each application or a DNN/S-NSSAI pair identified by information received from an AF. In this case, when the AM PCF receives information indicating that the S-NSSAI has been replaced with the alternative S-NSSAI, the AM PCF may add the alternative S-NSSAI instead of the S-NSSAI.

### Address Information for Reception of a Notification (e.g., a Callback URI)

Indication of registration or deregistration: When the AM PCF determines, based on a notification transmitted by the BSF, that access and mobility-related policy information may change when establishing and terminating an SM policy association for DNN and S-NSSAI, the AM PCF may add an indication of registration or deregistration per DNN/S-NSSAI to the message transmitted to the BSF. The BSF reports SM PCF registration when a first SM policy association is established for corresponding S-NSSAI and DNN, and reports SM PCF deregistration when a last SM policy association is terminated for corresponding S-NSSAI and DNN.

The SM PCF may transmit the message of step 406a or the message of step 406b only if the message of step 404 includes a retained indication.

The SM PCF may transmit the message of step 406a or the message of step 406b only if the message of step 404 does not include a not-retained indication.

When PDU session re-establishment is determined in step 404, the SMF may transmit, to the UE in step 406, information indicating to request PDU session re-establishment with the alternative S-NSSAI.

The SMF may release the existing PDU session before PDU session re-establishment, or release the existing PDU session after PDU session re-establishment.

The UE may transmit the PDU session establishment request message including the alternative S-NSSAI, the S-NSSAI, and a PDU session ID to the AMF.

In step 407, the AMF may select a new SMF (SMF2) based on the alternative S-NSSAI, and transmit an SM context create message including the PDU session ID, the alternative S-NSSAI, and the S-NSSAI to the SMF.

When the message of step 407 is received, the SMF2 may select a new SM PCF and perform SM policy association establishment via a corresponding SM PCF (SM PCF2), in step 408. Alternatively, the SMF2 may select and use the existing SM PCF (e.g., the PCF for the S-NSSAI, DNN, and SUPI of the message received in step 407).

In this case, when the alternative S-NSSAI and the S-NSSAI are received in step 407, a message including one or more of the SUPI, DNN alternative S-NSSAI, and S-NSSAI may be transmitted to the SM PCF2.

When the message received in step 408 includes the alternative S-NSSAI and the S-NSSAI, the SM PCF2 may include both the S-NSSAI and the alternative S-NSSAI in a registration message transmitted to the BSF in step 409.

When the BSF receives the subscription request message including the alternative S-NSSAI from the AM PCF in step 405, if binding information including the alternative S-NSSAI is generated in step 409, the BSF may transmit a message for notifying of the generated information to the AM PCF in step 410.

The message may include DNN, alternative S-NSSAI, UE address, SUPI, notification of registration (i.e., information indicating that the SM PCF has been registered with DNN and alternative S-NSSAI), and PCF address, but the disclosure is not limited thereto.

When the message of step 407 is received, the AM PCF may update the RFSP index or SAR in step 411.

In step 412, when the AM PCF determines to update the RFSP index, the AM PCF may transmit the updated RFSP index to the RAN via the AMF. When the updated RFSP index is received, the RAN may transmit corresponding cell reselection priority to the UE.

In step 413, when the AM PCF determines to update the SAR, the AM PCF may transmit the updated SAR to the UE via the AMF and the RAN.

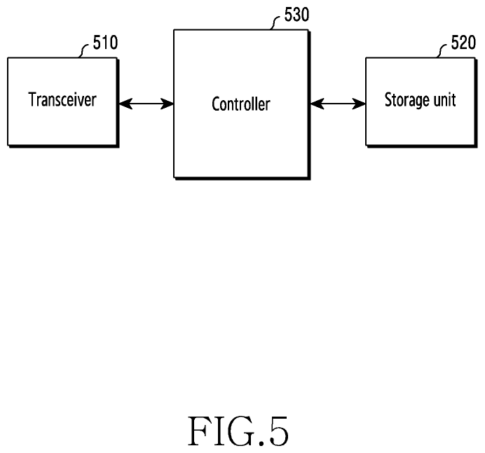

FIG. 5 illustrates a structure of a UE according to an embodiment.

Referring to FIG. 5, a UE may include a controller (control unit) 530, a transceiver 510, and a storage (memory) 520. However, components of the UE are not limited to the above-described example. For example, the UE may include fewer or more components than the above-described components. The controller 530, the transceiver 510, and the storage 520 may be implemented in the form of a single chip. The controller 530 of FIG. 5 may include at least one processor or controller.

The controller 530 may control a series of processes such that the UE can operate according to the above-described embodiments of the disclosure. For example, The controller 530 may control the components of the UE to perform transmission and reception methods of the UE according to whether the base station mode is a base station power saving mode or a base station normal mode. The controller 530 may include one or multiple controllers, and the controller 530 may execute programs stored in the storage 520 to perform transmission and reception operations of the UE in a wireless communication system employing the above-described carrier aggregation of the disclosure.

The transceiver 510 may transmit/receive signals with the base station. The signals transmitted/received with the base station may include control information and data. The transceiver 510 may include an RF transmitter configured to up-convert and amplify the frequency of transmitted signals, an RF receiver configured to low-noise-amplify received signals and down-convert the frequency thereof, and the like. However, the components of the transceiver 510 are not limited to the RF transmitter and the RF receiver. The transceiver 510 may receive signals through a radio channel, output the signals to the controller 530, and transmit signals output from the controller 530 through the radio channel.

The storage 520 may store programs and data necessary for operations of the UE. The storage 520 may store control information or data included in signals transmitted/received by the UE. The storage 520 may include storage media such as a read only memory (ROM), a random access memory (RAM), a hard disk, a compact disc (CD)-ROM, and a digital versatile disc (DVD), or a combination of storage media. The storage 520 may include multiple storages. The storage 520 may store programs for performing transmission and reception operations of the UE according to whether the base station mode is a base station power saving mode or a base station normal mode.

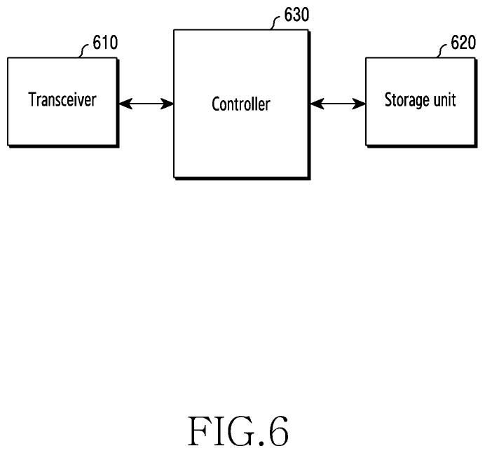

FIG. 6 illustrates a structure of a base station according to an embodiment.

Referring to FIG. 6, a base station of the disclosure may include a controller (control unit) 630, a transceiver 610, and a storage (memory) 620. However, components of the base station are not limited to the above-described example. For example, the base station may include fewer or more components than the above-described components. The controller 630, the transceiver 610, and the storage 620 may be implemented in the form of a single chip. The controller 630 of FIG. 6 may include at least one processor or controller.

The controller 630 may control a series of processes such that the base station can operate according to the above-described embodiments of the disclosure. For example, The controller 630 may control the components of the base station to perform UE scheduling methods according to whether the base station mode is a base station power saving mode or a base station normal mode. The controller 630 may include one or multiple controllers, and may execute programs stored in the storage 620 to perform UE scheduling methods according to whether the above-described base station mode is a base station power saving mode or a base station normal mode.

The transceiver 610 may transmit/receive signals with the UE. The signals transmitted/received with the UE may include control information and data. The transceiver 610 may include an RF transmitter configured to up-convert and amplify the frequency of transmitted signals, an RF receiver configured to low-noise-amplify received signals and down-convert the frequency thereof, and the like. However, the components of the transceiver 610 are not limited to the RF transmitter and the RF receiver. The transceiver 610 may receive signals through a radio channel, output the signals to the controller 630, and transmit signals output from the controller 630 through the radio channel.

The storage 620 may store programs and data necessary for operations of the base station. The storage 620 may store control information or data included in signals transmitted/received by the base station. The storage 620 may include storage media such as a ROM, a RAM, a hard disk, a CD-ROM, and a DVD, or a combination of storage media. The storage 620 may include multiple storages. The storage 620 may store programs for performing UE scheduling methods according to whether the base station mode is a base station power saving mode or a base station normal mode.

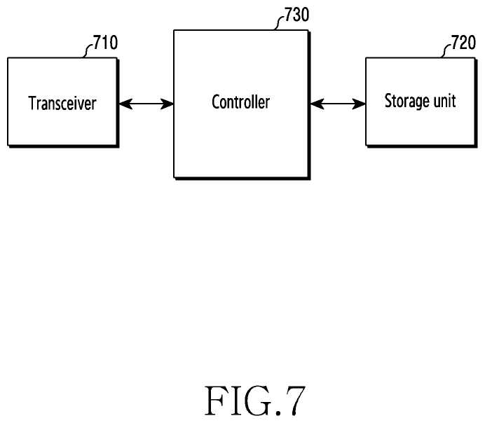

FIG. 7 illustrates a structure of a network entity according to an embodiment.

Referring to FIG. 7, a network entity of the disclosure may include a controller 730, a transceiver 710, and a storage (or memory) 720. However, components of the network entity are not limited to the above-described example. For example, the network entity may include fewer or more components than the above-described components. The controller 730, the transceiver 710, and the storage 720 may be implemented in the form of a single chip. The network entity may refer to NF including an AMF, an SMF, a PCF, a UDM, a DN, an AF, a UPF, an NSSF, an NWDAF, an NSACF, etc.

The controller 730 may control a series of processes so that the NF can operate according to the above-described embodiments of the disclosure. For example, the controller 730 may control the components of the network entity to perform the methods for providing broadcast services according to the above-described embodiments. The controller 730 may control the components of the network entity to perform the embodiments of the disclosure by executing the programs stored in the storage 720. The controller 730 may be an application processor (AP), a communication processor (CP), a circuit, an application-specific circuit, or at least one processor.

The transceiver 710 may transmit/receive signals with other network entities, base stations, or UEs. The signals transmitted/received with other network entities or UEs may include control information and data. The transceiver 710 may include an RF transmitter configured to up-convert and amplify the frequency of transmitted signals, an RF receiver configured to low-noise-amplify received signals and down-convert the frequency thereof, and the like. However, the components of the transceiver 710 are not limited to the RF transmitter and the RF receiver. The transceiver 710 may receive signals through a radio channel, output the signals to the controller 730, and transmit signals output from the controller 730 through the radio channel.

The storage 720 may store programs and data necessary for operations of the network entity. The storage 720 may store control information or data included in signals transmitted/received by the network entity. The storage 720 may include storage media such as a ROM, a RAM, a hard disk, a CD-ROM, and a DVD, or a combination of storage media. The storage 720 may include multiple storages. The storage 720 may store programs for executing the above-described network slice change supporting methods.

It should be noted that the above-described figures, the above respective embodiments may be employed in combination, as necessary. For example, the methods in the disclosure may be partially combined with each other to operate a network entity and a terminal.

The above-described operations of a base station or terminal may be implemented by providing any unit of the base station or terminal device with a memory device storing corresponding program codes. That is, a controller of the base station or terminal device may perform the above-described operations by reading and executing the program codes stored in the memory device by means of a processor or central processing unit (CPU).

Various units or modules of an entity, a base station device, or a terminal device may be operated using hardware circuits such as complementary metal oxide semiconductor-based logic circuits, firmware, or hardware circuits such as combinations of software and/or hardware and firmware and/or software embedded in a machine-readable medium. For example, various electrical structures and methods may be implemented using transistors, logic gates, and electrical circuits such as application-specific integrated circuits.

Herein, each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks.

These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

Herein, the term “unit” refers to a software element or a hardware element, such as a field programmable gate array (FPGA) or an application specific integrated circuit (ASIC), and the unit may perform certain functions. However, the unit does not always have a meaning limited to software or hardware. The unit may be constructed either to be stored in an addressable storage medium or to execute one or more processors.

Therefore, the unit includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters.

The elements and functions provided by the unit may be either combined into a smaller number of elements, or a unit, or divided into a larger number of elements, or a unit. Moreover, the elements and units may be implemented to reproduce one or more CPUs within a device or a security multimedia card. The unit in embodiments may include one or more processors.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to the disclosure.

These programs (software modules or software) may be stored in non-volatile memories including a random access memory and a flash memory, a ROM, an electrically erasable programmable read only memory (EEPROM), a magnetic disc storage device, a CD-ROM, DVDs, or other type optical storage devices, or a magnetic cassette. Alternatively, any combination of some or all of them may form a memory in which the program is stored. A plurality of such memories may be included in the electronic device.

The programs may be stored in an attachable storage device which can access the electronic device through communication networks such as the Internet, Intranet, local area network (LAN), Wide LAN (WLAN), and storage area network (SAN) or a combination thereof. Such a storage device may access the electronic device via an external port. A separate storage device on the communication network may access a portable electronic device.

While the disclosure has been described with reference to various embodiments, various changes may be made without departing from the spirit and the scope of the present disclosure, which is defined, not by the detailed description and embodiments, but by the appended claims and their equivalents.

What is claimed is:

1. A method performed by a session management policy control function (SM PCF) entity in a wireless communication system, comprising:
receiving, from a session management function (SMF) entity, an SM policy control update request message including information for identifying a alternative network slice and information related to whether to retain a protocol data unit (PDU) session;
identifying a network slice replacement based on the received SM policy control update request message; and
transmitting, to at least one network function (NF) entity, an event exposure notify message including at least one of the information for identifying the alternative network slice or the information related to occurrence of the network slice replacement.

2. The method of claim 1, further comprising:
in case that retainment of the PDU session is identified based on the information related to whether to retain the PDU session, transmitting, to a binding support function (BSF) entity, a message for updating binding information for the PDU session and the alternative network slice.

3. The method of claim 2,
wherein the message for updating the binding information includes at least one of a binding identifier, an identifier of the alternative network slice, or an indicator instructing to add the alternative network slice to the binding information.

4. The method of claim 1, further comprising:
in case that release of the PDU session is identified based on the information related to whether to retain the PDU session, transmitting, to the BSF entity, a message for creating binding information for the PDU session and the alternative network slice.

5. The method of claim 1, further comprising:
receiving a subscription request related to the alternative network slice from the at least one NF entity.

6. A method performed by a network function (NF) entity in a wireless communication system, comprising:
receiving, from a session management policy control function (SM PCF) entity, an event exposure notify message including at least one of information for identifying a alternative network slice or information related to occurrence of a network slice replacement,
wherein the event exposure notify message is based on an SM policy control update request message, and
wherein the SM policy control update request message includes information for identifying the alternative network slice and information related to whether to retain a protocol data unit (PDU) session.

7. The method of claim 6, further comprising:
in case that retainment or release of the PDU session is identified based on the information related to whether to retain the PDU session included in the SM policy control update request message, receiving a binding support function (BSF) notify message including information related to the alternative network slice from a BSF entity.

8. The method of claim 7,
wherein the BSF notify message is based on a message for creating or updating binding information, and
wherein the message for creating or updating the binding information includes at least one of a binding identifier, an identifier of the alternative network slice, or an indicator instructing to add the alternative network slice to the binding information.

9. The method of claim 6, further comprising:
transmitting a subscription request related to the alternative network slice to the BSF entity.

10. The method of claim 6, further comprising:
transmitting a subscription request related to the alternative network slice to the SM PCF entity.

11. A session management policy control function (SM PCF) entity in a wireless communication system, comprising:
a transceiver; and
a controller coupled to the transceiver, wherein the controller is configured to:
receive, from a session management function SMF) entity, an SM policy control update request message including information for identifying a alternative network slice and information related to whether to retain a protocol data unit (PDU) session,
identify a network slice replacement based on the received SM policy control update request message, and
transmit, to at least one network function (NF) entity, an event exposure notify message including at least one of the information for identifying the alternative network slice or the information related to occurrence of the network slice replacement.

12. The SM PCF entity of claim 11,
wherein the controller is further configured to transmit, to a binding support function (BSF) entity, a message for updating binding information for the PDU session and the alternative network slice, in case that retainment of the PDU session is identified based on the information related to whether to retain the PDU session.

13. The SM PCF entity of claim 12,
wherein the message for updating the binding information includes at least one of a binding identifier, an identifier of the alternative network slice, or an indicator instructing to add the alternative network slice to the binding information.

14. The SM PCF entity of claim 11,
wherein the controller is further configured to transmit, to the BSF entity, a message for creating binding information for the PDU session and the alternative network slice, in case that release of the PDU session is identified based on the information related to whether to retain the PDU session.

15. The SM PCF entity of claim 11,
wherein the controller is further configured to receive a subscription request related to the alternative network slice from the at least one NF entity.

16. A network function (NF) entity in a wireless communication system, comprising:
a transceiver; and
a controller coupled to the transceiver, wherein the controller is configured to:
receive, from a session management policy control function (SM PCF) entity, an event exposure notify message including at least one of information for identifying a alternative network slice or information related to occurrence of a network slice replacement,
wherein the event exposure notify message is based on an SM policy control update request message, and
wherein the SM policy control update request message includes information for identifying the alternative network slice and information related to whether to retain a protocol data unit (PDU) session.

17. The NF entity of claim 16,
wherein the controller is further configured to receive a binding support function (BSF) notify message including information related to the alternative network slice from a BSF entity, in case that retainment or release of the PDU session is identified based on the information related to whether to retain the PDU session included in the SM policy control update request message.

18. The NF entity of claim 17,
wherein the BSF notify message is based on a message for creating or updating binding information, and
wherein the message for creating or updating the binding information includes at least one of a binding identifier, an identifier of the alternative network slice, or an indicator instructing to add the alternative network slice to the binding information.

19. The NF entity of claim 16,
wherein the controller is further configured to transmit a subscription request related to the alternative network slice to the BSF entity.

20. The NF entity of claim 16,
wherein the controller is further configured to transmit a subscription request related to the alternative network slice to the SM PCF entity.
